(19) United States
(12) Patent Application Publication
(10) Pub. No.: US 2006/0095414 A1
(43) Pub. Date: May 4, 2006

(54) System and method for integrating and transmitting data

(75) Inventor: I-Ching Li, Shindian City (TW)

Correspondence Address: BIRCH STEWART KOLASCH & BIRCH, PO BOX 747, FALLS CHURCH, VA, 22040-0747, US

(73) Assignee: VIA Technologies, Inc.

(21) Appl. No.: 11/119,768

(22) Filed: May 3, 2005

(30) Foreign Application Priority Data
Oct. 26, 2004 (TW) 093132450

(51) Int. Cl. G06F 17/30

(52) U.S. Cl. 707/3

(57) ABSTRACT

A system for integrating and transmitting data comprises a request receiving module, which receives download requests from first heterogeneous databases by a main server; a list establishing module, which establishes corresponding download lists according to the download requests; a data selecting module, which selects download data from second heterogeneous databases and receives the download data by the main sever according to the download lists; and a data transmitting module, which transmits the download data to the first heterogeneous databases according to the download lists.

### BACKGROUND OF THE INVENTION

1. Field of Invention

The invention relates to a data transmitting system and method and, in particular, to a system and a method for integrating and transmitting data.

2. Related Art

The big-scale enterprise usually has huge organization, complex technology resources and variant products. To properly manage the information of the enterprise (such as the personnel matters, manufacturing equipments, research, financial affairs and the likes), it is necessary to build a database for immediately and exactly managing the above-mentioned important information. However, the enterprise may have many branches distributed at different locations all over the world across the limitations of ocean and land. Different branches have different information of personnel matters, manufacturing equipments, research, financial affairs and the likes, so that they may have databases of different specifications. These factors will make the instantaneous integration of information in the entire enterprise non-smoothly, and thus the staff member must do some extra works to get and integrate the data from different branches.

In the conventional art, a loader is provided to download data from a database and then to transform the format of the downloaded data so as to transmit data between heterogeneous databases. FIG. 1 shows several heterogeneous databases including a first database 11, a second database 12, a third database 13 and a fourth database 14. The fourth database 14 links to the first database 11, the second database 12 and the third database 13 in advance, and utilizes a loader 141, a loader 142 and a loader 143 to download data from the first database 11, the second database 12 and the third database 13 respectively. The downloaded data are then transformed to match the format of the fourth database 14. If another database is created or the format of the database is changed, the database manager must develop new loader for the additional database or maintain the existing loader. By doing so, the fourth database can get data from other databases and transform the format of the data into usable format of data. In addition, if each of the heterogeneous databases must have specific loaders for it, the amount of loader for one database is increased corresponding to the number of other databases. When the number of all databases is huge, the total amount of loaders for all databases is accordingly considerable. Besides, when different databases use their loaders to get the same data from one database, the retrieved data for different databases may have different contents due to that the time points for getting the data are variant. Accordingly, the data, which should ideally have the same contents in different databases, may actually have different contents in different databases.

The complex networks (or links) including the great amount of databases make the maintenance of the databases and loaders more difficult. The data transmission mechanism between different databases must be individually negotiated in advance, so as to ensure the correctness of the downloaded data. Therefore, by simplifying the complex networks including the great amount of databases, the loading for maintenance of the databases and loaders can be released.

It is therefore an important subjective of the invention to provide a system and a method for integrating and transmitting data, which can provide data download service between heterogeneous databases and transform the formats of data to match individual one of the heterogeneous databases. Thus, each of the heterogeneous databases can get needed data from other heterogeneous databases, and the data stored in the databases are instantaneous and correct.

### SUMMARY OF THE INVENTION

In view of the foregoing, the invention is to provide a system and a method for integrating and transmitting data.

To achieve the above, a system for integrating and transmitting data of the invention includes a request receiving module, a list establishing module, a data retrieving module, and a data transmitting module. The request receiving module receives a plurality of download requests from first heterogeneous databases by a main server. The list establishing module establishes a plurality of corresponding download lists according to the download requests. The data retrieving module selects a plurality of download data from second heterogeneous databases according to the download lists and receives the selected download data by the main sever. The data transmitting module transmits the download data to the first heterogeneous databases according to the download lists.

To achieve above, a method for integrating and transmitting data of the invention includes the following steps of: receiving a plurality of download requests from first heterogeneous databases by a main server, establishing a plurality of corresponding download lists according to the download requests, selecting a plurality of download data from second heterogeneous databases according to the download lists, receiving the selected download data by the main sever, and transmitting the download data to the first heterogeneous databases according to the download lists.

As mentioned above, the system and method for integrating and transmitting data of the invention can transmit and transform the data to be downloaded to each heterogeneous database. Thus, each heterogeneous database can get needed data from other heterogeneous databases, and the retrieved data are instantaneous and correct.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional database that utilizes loaders for downloading data;

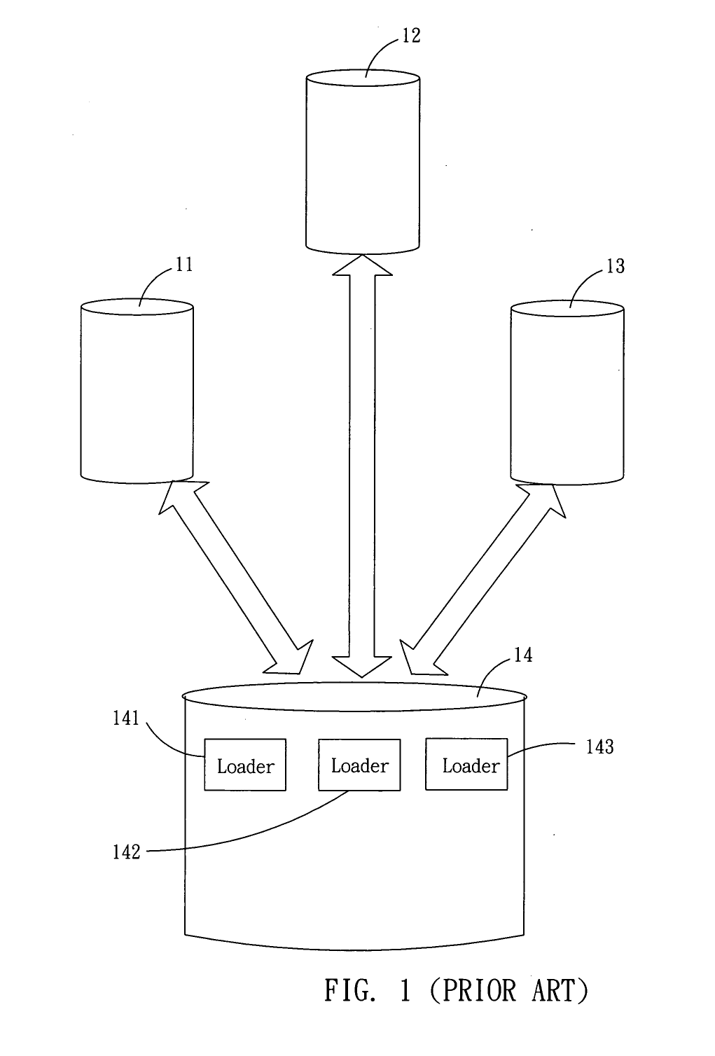

FIG. 2 is a schematic view showing a system for integrating and transmitting data according to a preferred embodiment of the invention;

FIG. 3 is a schematic view showing the system for integrating and transmitting data according to a preferred embodiment of the invention, wherein the download lists are established according to the download requests and the download data are transmitted according to the download lists;

FIG. 4 is a schematic view showing a system for integrating and transmitting data according to another preferred embodiment of the invention;

FIG. 5 is a schematic view showing the system for integrating and transmitting data according to another preferred embodiment of the invention, wherein the download lists are established according to the download requests and the download data are transmitted according to the download lists;

FIG. 6 is a schematic view showing a system for integrating and transmitting data according to still another preferred embodiment of the invention, wherein the display module outputs the data on a window;

FIG. 7 is a flow chart showing a method for integrating and transmitting data according to a preferred embodiment of the invention; and

FIG. 8 is a flow chart showing a method for integrating and transmitting data according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

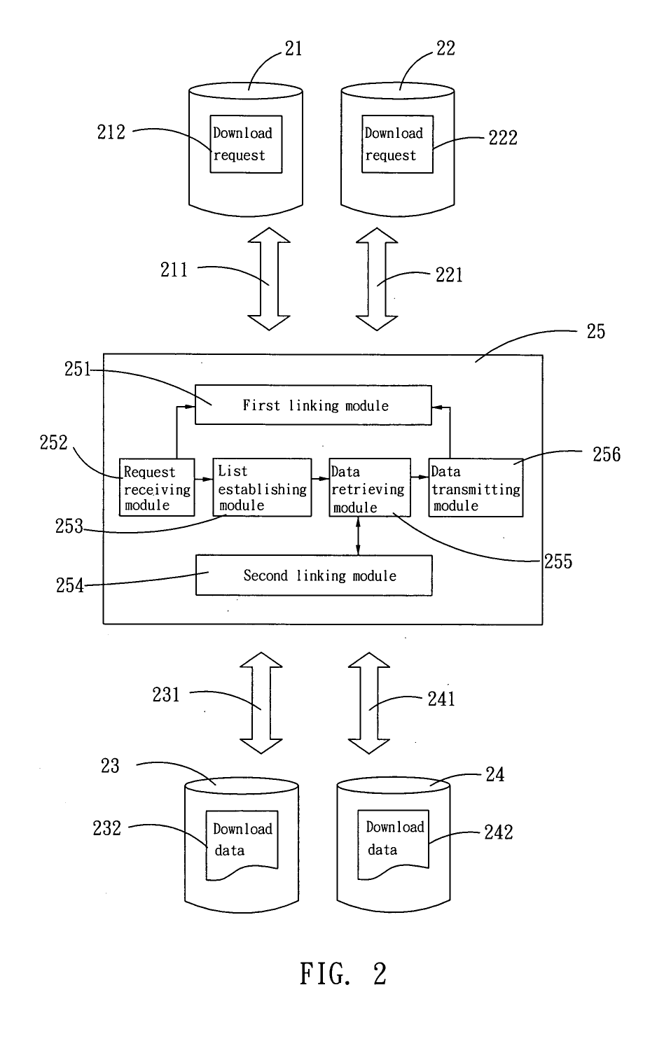

With reference to FIG. 2, a system for integrating and transmitting data according to a preferred embodiment of the invention includes a first linking module 251, a request receiving module 252, a list establishing module 253, a second linking module 254, a data retrieving module 255, and a data transmitting module 256. In the embodiment, the first linking module 251, the request receiving module 252, the list establishing module 253, the second linking module 254, the data retrieving module 255, and the data transmitting module 256 are provided in a main server 25.

The first linking module 251 establishes a first link 211 between the main server 25 and the first heterogeneous database 21 and another first link 221 between the first heterogeneous database 22 and the main server 25. The request receiving module 252 receives download requests 212 and 222 respectively from the first heterogeneous databases 21 and 22. The list establishing module 253 establishes a plurality of corresponding download lists according to the download requests 212 and 222.

In the present embodiment, the download request 212 and download request 222 can be the instructions to ask the main server 25 to download some data for the first heterogeneous database 21 and first heterogeneous database 22. The download list includes designated download data, a download source, and a destination. The designated download data indicate the data to be downloaded. The download source indicates one of the second heterogeneous databases, such as the second heterogeneous database 23 or the second heterogeneous database 24, storing the designated download data to be downloaded. The destination indicates one of the first heterogeneous databases, such as the first heterogeneous database 21 or the first heterogeneous database 22, to which the download data are transmitted.

The second linking module 254 establishes a second link 231 between the main server 25 and the second heterogeneous database 23 and another second link 241 between the main server 25 and the second heterogeneous database 24 according to the download lists.

The data retrieving module 255 selects download data 232 from the second heterogeneous database 23 and download data 242 from the second heterogeneous database 24 according to the download lists. Then, the data retrieving module 255 receives the selected download data 232 and 242 to the main sever 25. In the present embodiment, according to the designated download data and download source listed in the download lists, the data retrieving module 255 selects the download data 232 and 242 from the second heterogeneous databases 23 and 24, and receives the selected download data 232 and 242 to the main sever 25.

The data transmitting module 256 transforms the formats of the download data 232 and 242 to match the format of the first heterogeneous database 21 and the format of the first heterogeneous database 22. After that, the data transmitting module 256 transmits the download data 232 and 242 to the first heterogeneous databases 23 and 24 according to the download lists. In the current embodiment, the data transmitting module 256 transforms the formats of the download data 232 and 242 to match the format of the first heterogeneous database 21 and the format of the first heterogeneous database 22 according to the destinations of the download lists, and then transmits the download data 232 and 242 to the first heterogeneous databases 23 and 24. Besides, the main server 25 is not a database or excludes a database, so that the download data 232 and 242 are not stored in the main server 25 after the main server 25 transmits them. The first link 211, first link 221, second link 231 and second link 241 can be Internet links. Thus, the locations of the main server 25, first heterogeneous database 21, first heterogeneous database 22, second heterogeneous database 23, and second heterogeneous database 24 would not be limited. The main server 25, first heterogeneous database 21, first heterogeneous database 22, second heterogeneous database 23, and second heterogeneous database 24 can be located in any place around the world and be connected through the Internet links.

In another embodiment, the data transmitting module 256 may transmit the download data 232 and 242 to the first heterogeneous databases 21 and 22 located in different time zones at different time according to the destinations of the download lists and time zones of the destinations.

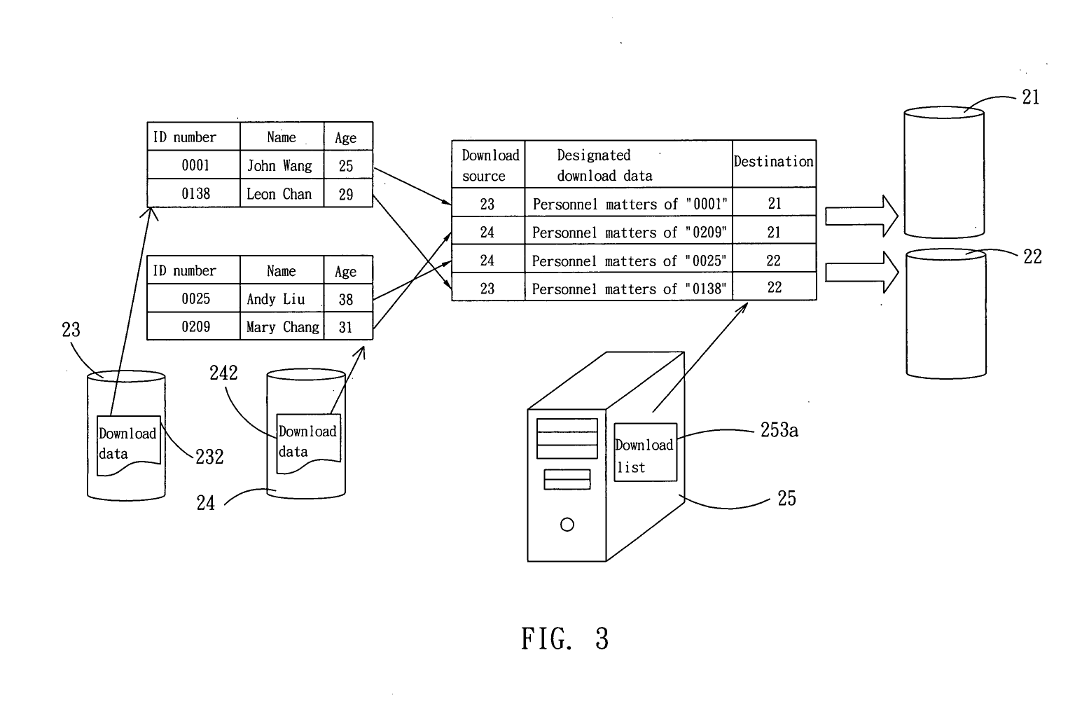

With reference to FIG. 3, after the list establishing module 253 establishes a plurality of download lists 253a according to the download requests 212 and 222, the data retrieving module 255 selects and receives download data 232 from the second heterogeneous database 23 according to the download source and designated download data in the download list 253a. The content of the download data 232 includes the personnel matters of “John Wang” requested by the download request 212 and the personnel matters of “Leon Chan” requested by the download request 222. In addition, the data retrieving module 255 selects and receives download data 242 from the second heterogeneous database 24 according to the download source and designated download data in the download list 253a. The content of the download data 242 includes the personnel matters of “Andy Liu” requested by the download request 212 and the personnel matters of “Mary Chang” requested by the download request 222.

According to the destination of the download list 253a and a time zone of the destination, the data transmitting module 256 transforms the formats of the personnel matters of “John Wang” and “Mary Chang” to match the format of the first heterogeneous database 21, and then transmits the personnel matters of “John Wang” and “Mary Chang” to the first heterogeneous database 21 before the office hours of where the first heterogeneous database 21 is located. Furthermore, according to the destination of the download list 253a and a time zone of the destination, the data transmitting module 256 transforms the formats of the personnel matters of “Andy Liu” and “Leon Chan” to match the format of the first heterogeneous database 22, and then transmits the personnel matters of “Andy Liu” and “Leon Chan” to the first heterogeneous database 22 before the office hours of where the first heterogeneous database 22 is located. The main server 25 will delete the temporary download data 232 and 242 after the transmission is completed.

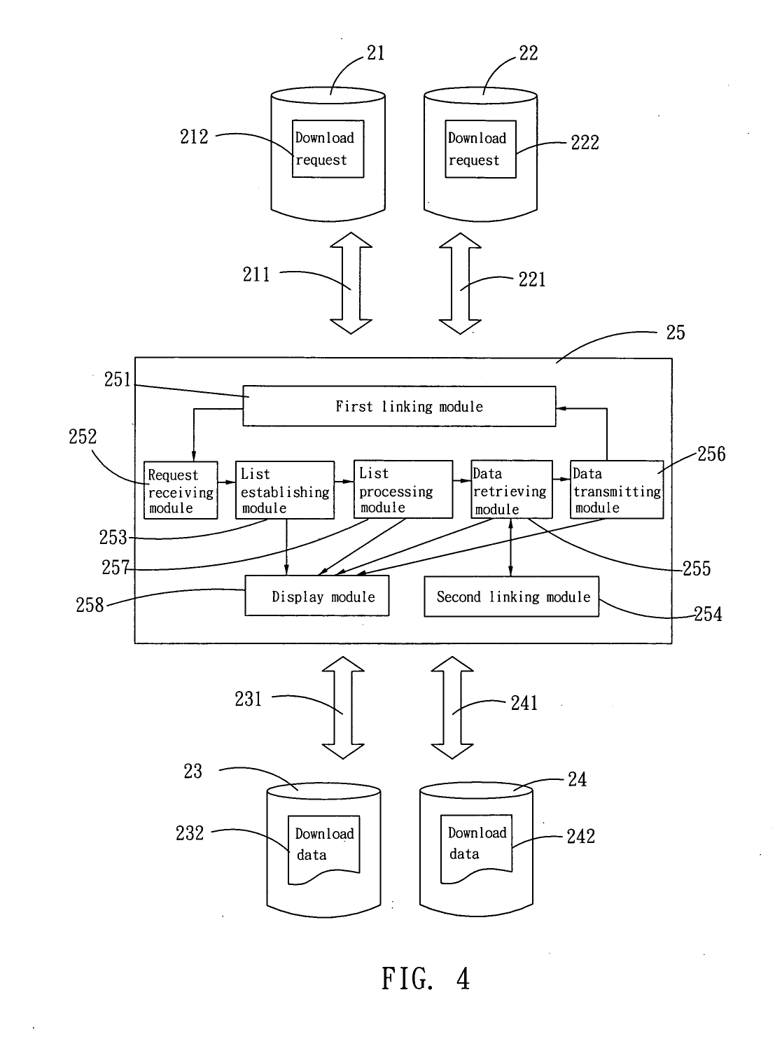

Referring to FIG. 4, a system for integrating and transmitting data according to still another embodiment of the invention, which is differ from that shown in FIG. 2, further includes a list processing module 257 and a display module 258, which are provided in the main server 25. The list processing module 257 can sort the download lists according to the download source or destination of each download list. The display module 258 displays processing procedures of the system of the embodiment on a user interface, such as a window.

Each download list may further include a download tag for illustrating necessary downloading or unnecessary downloading. When the download list is tagged with necessary downloading, the main server 25 would not receive the designated download data of the download list from the second heterogeneous database 23 or 24. According to the download tag, the duplicate data downloaded from the first heterogeneous databases 21 and 22 can be avoided.

The list processing module 257 determines whether to download duplicate data according to designated download data and download sources of the download lists. When the download lists include duplicate data, the list processing module 257 tags one of the download lists including the duplicate data with a download tag of necessary downloading and the residual of the download lists including the duplicate data with a download tag of unnecessary downloading. In addition, when the download lists do not include duplicate data, the list processing module 257 tags the download lists with a download tag of necessary downloading.

The data retrieving module 255 firstly selects the download lists with the download tag of necessary downloading, then selects the download data 232 from the second heterogeneous database 23 and the download data 242 from the second heterogeneous database 24 according to the download source and the designated download data of the selected download lists, and finally receives the selected download data 232 and 242 to the main sever 25.

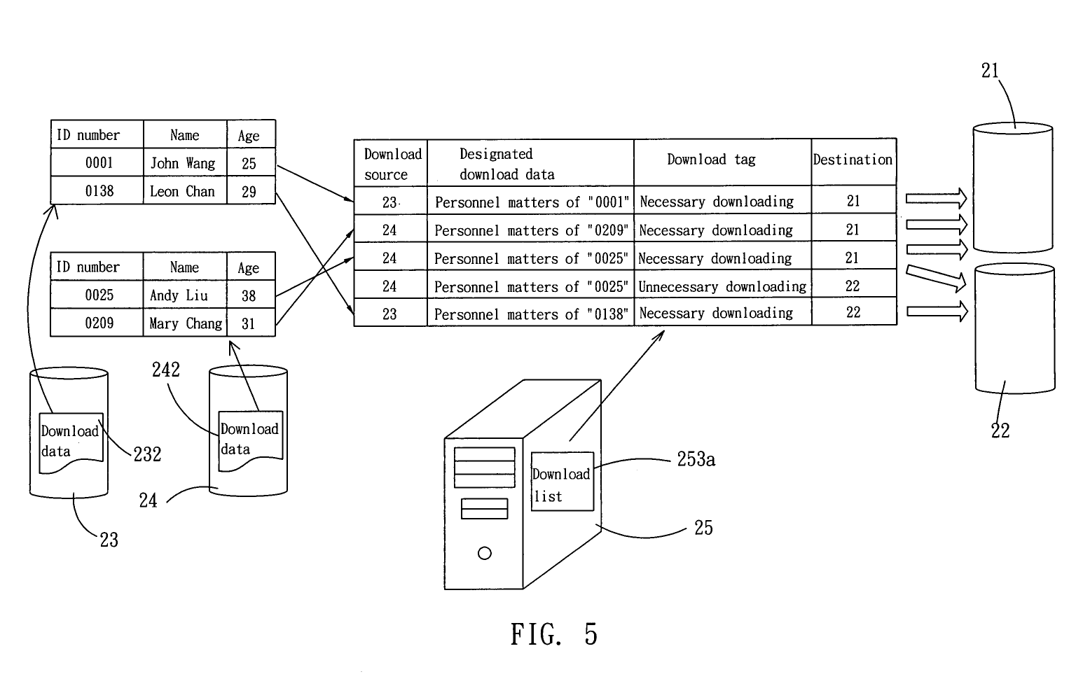

With reference to FIG. 5, the list processing module 257 sorts the download lists 253a according to the destinations of the download lists 253a. For example, the first heterogeneous database 21 is superior to the first heterogeneous database 22. In addition, the download requests from the first heterogeneous databases 21 and 22 both request the personnel matters of “Andy Liu” in the second heterogeneous database 24. In the embodiment, the download list 253a with the destination indicating to the first heterogeneous database 21 is selected and tagged with a download tag of necessary downloading. In addition, the download list 253a with the destination indicating to the first heterogeneous database 212 is selected and tagged with a download tag of unnecessary downloading. The residual download lists 253a do not request the same download data are tagged with a download tag of necessary downloading.

The data retrieving module 255 firstly selects the download lists 253a with the download tag of necessary downloading, then selects and retrieves the personnel matters of “John Wang” and “Leon Chan” from the second heterogeneous database 23 and the personnel matters of “Andy Liu” and “Mary Chang” from the second heterogeneous database 24 according to the download sources and the designated download data of the selected download lists 253a.

According to the destination of the download list 253a, the data transmitting module 256 transforms the formats of the personnel matters of “John Wang”, “Andy Liu” and “Mary Chang” to match the format of the first heterogeneous database 21, and then transmits the personnel matters of “John Wang”, “Andy Liu” and “Mary Chang” to the first heterogeneous database 21. Furthermore, according to the destination of the download list 253a, the data transmitting module 256 transforms the formats of the personnel matters of “Andy Liu” and “Leon Chan” to match the format of the first heterogeneous database 22, and then transmits the personnel matters of “Andy Liu” and “Leon Chan” to the first heterogeneous database 22. The main server 25 will delete the temporary download data 232 and 242 after the transmission is completed.

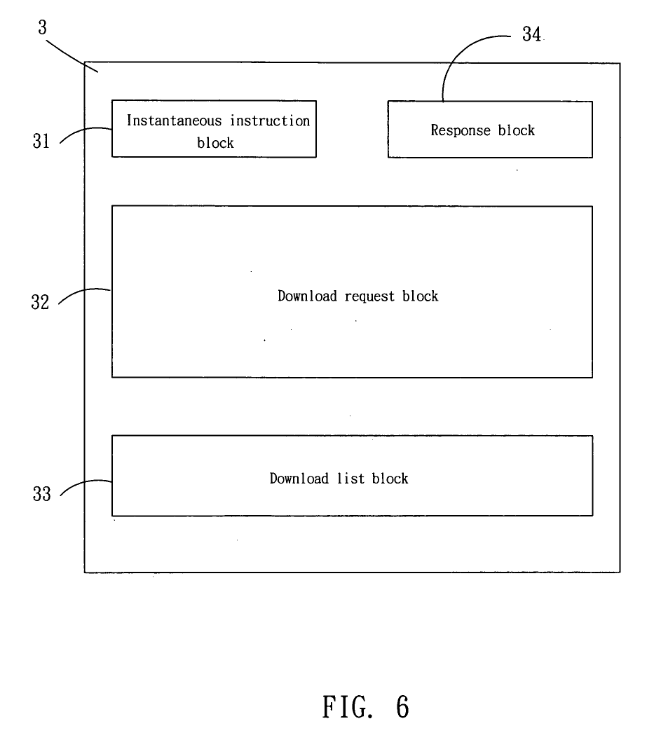

With reference to FIG. 6, the display module 258 displays processing procedures of the system for integrating and transmitting data of the embodiment on a window 3. The window 3 includes an instantaneous instruction block 31, a download request block 32, a download list block 33 and a response block 34. The instantaneous instruction block 31 is for a user to issue an instruction, so that the user can submit required instructions to operate the system. The download request block 32 displays the download requests 212 and 222 received by the request receiving module 252. The download list block 33 displays the download, lists, which are established by the list establishing module 253 or processed by the list processing module 257. The response block 34 displays the system state information, responses the instructions issued by the user, or displays the processing state of the system.

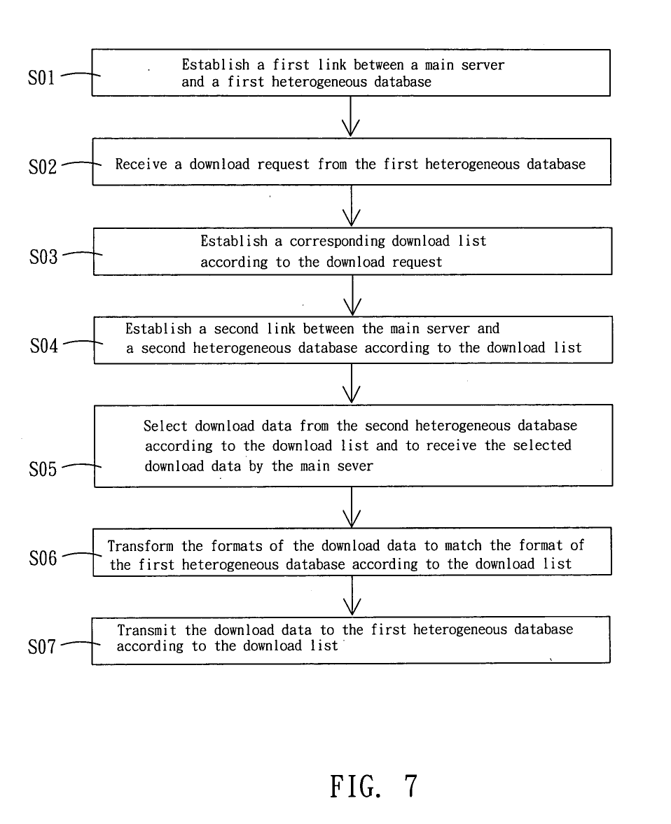

FIG. 7 shows a method for integrating and transmitting data according to a preferred embodiment of the invention. The method of the embodiment includes the following steps S01 to S07.

The step S01 is to establish a first link between a main server and a first heterogeneous database.

The step S02 is to receive a download request from the first heterogeneous database.

The step S03 is to establish a corresponding download list according to the download request.

The step S04 is to establish a second link between the main server and a second heterogeneous database according to the download list.

The step S05 is to select download data from the second heterogeneous database according to the download list and to receive the selected download data by the main sever.

The step S06 is to transform the formats of the download data to match the format of the first heterogeneous database according to the download list.

The step S07 is to transmit the download data to the first heterogeneous database according to the download list.

The detailed steps of the method for integrating and transmitting data of the embodiment are the same as illustrated in the previous embodiment with reference to FIGS. 2 and 3, so the detailed descriptions are omitted for concise purpose.

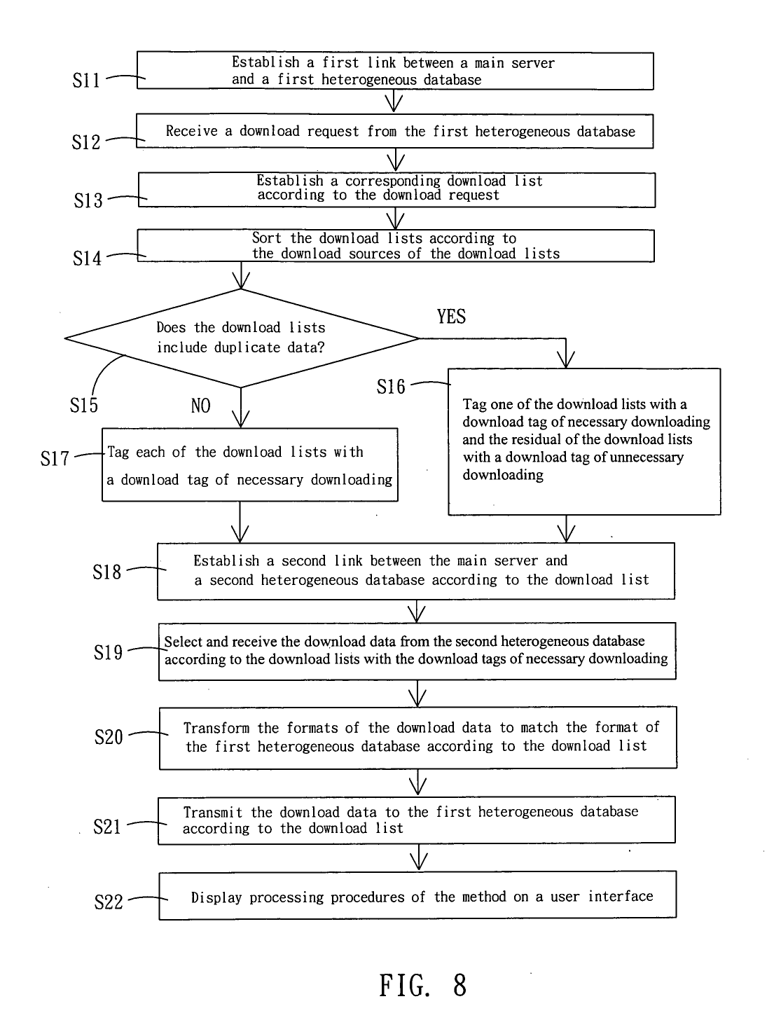

FIG. 8 shows a method for integrating and transmitting data according to another preferred embodiment of the invention. The method of the present embodiment includes the following steps S11 to S22, wherein the steps S11 to S13 are the same as the previously mentioned steps S01 to S03, the steps S18, S20 and S21 are the same as the previously mentioned steps S04, S06 and S07, so the detailed descriptions of the steps S11 to S13, S18, S20 and S21 are omitted for concise purpose.

The step S14 is to sort the download lists according to the download sources of the download lists.

The step S15 is to determine whether the download lists include duplicate data according to the designated download data and the download sources of the download lists. If the download lists include duplicate data, the step S16 is processed; otherwise, if the download lists do not include duplicate data, the step S17 is processed.

The step S16 is to tag one of the download lists with a download tag of necessary downloading and the residual of the download lists with a download tag of unnecessary downloading. After the step S16, the step S18 is processed.

The step S17 is to tag each of the download lists with a download tag of necessary downloading. After the step S17, the step S18 is processed.

The step 19 is to select and receive the download data from the second heterogeneous database according to the download lists with the download tags of necessary downloading.

The step S22 is to display processing procedures of the method for integrating and transmitting data of the embodiment on a user interface such as a window.

The detailed steps of the method for integrating and transmitting data of the present embodiment are the same as illustrated in the previous embodiment with reference to FIGS. 4 to 6, so the detailed descriptions are omitted for concise purpose.

In summary, the system and method for integrating and transmitting data of the invention can transmit and transform the data to be downloaded to each heterogeneous database. Thus, each heterogeneous database can get needed data from other heterogeneous databases, and the retrieved data are instantaneous and correct.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for integrating and transmitting data, which is for transmitting data between a plurality of first heterogeneous databases and a plurality of second heterogeneous databases, comprising:
receiving a plurality of download requests from the first heterogeneous databases by a main server;
establishing a plurality of corresponding download lists according to the download requests;
selecting a plurality of download data from the second heterogeneous databases according to the download lists;
receiving the selected download data by the main sever; and
transmitting the download data to the first heterogeneous databases according to the download lists.

2. The method of claim 1, further comprising:
establishing a plurality of first links between the main server and the first heterogeneous databases; and
establishing a plurality of second links between the main server and the second heterogeneous databases according to the download lists.

3. The method of claim 1, wherein each of the download lists comprises:
designated download data, wherein the step of selecting the download data from the second heterogeneous databases according to the download lists is to select the download data from the second heterogeneous databases according to the designated download data listed in the download lists;
a download source, which indicates one of the second heterogeneous databases storing the designated download data to be downloaded;
a destination, which indicates one of the first heterogeneous databases, wherein the step of transmitting the download data to the first heterogeneous databases according to the download lists is to transmit the download data to one of the first heterogeneous databases indicated by the destination; and
a download tag, which is tagged to one of the designated download data, wherein the method is to determine whether to receive the selected download data by the main sever according to the download tag.

4. The method of claim 3, further comprising:
determining whether the download lists include duplicate data according to the designated download data and the download source of each of the download lists;
when the download lists include duplicate data, tagging one of the download lists with necessary downloading and the residual of the download lists with unnecessary downloading; and
when the download lists do not include duplicate data, tagging all of the download lists with necessary downloading.

5. The method of claim 3, wherein the step of establishing the corresponding download lists according to the download requests comprises:
establishing the destination, the designated download data and the download source in each of the download lists according to the first heterogeneous databases issuing the download requests and data to be downloaded designated in the download requests;
selecting the download data from the second heterogeneous databases according to the download source, the designated download data and the download tag of each of the download lists; and
transmitting the download data to the first heterogeneous databases according to the destination of each of the download lists.

6. The method of claim 3, further comprising:
sorting the download lists according to at least one of the download source and the destination.

7. The method of claim 3, wherein the step of transmitting the download data to the first heterogeneous databases according to the download lists is to transmit the download data to the first heterogeneous databases located in different time zones according to the destination of each of the download lists and a time zone of the destination.

8. The method of claim 1, further comprising:
displaying processing procedures of the method on a user interface.

9. The method of claim 1, wherein at least one of a group of the first links and a group of the second links are a plurality of Internet links.

10. The method of claim 1, wherein the main server excludes a database.

11. A system for integrating and transmitting data, which is for transmitting data between a plurality of first heterogeneous databases and a plurality of second heterogeneous databases, comprising:
a request receiving module, which receives a plurality of download requests from the first heterogeneous databases by a main server;
a list establishing module, which establishes a plurality of corresponding download lists according to the download requests;
a data retrieving module, which selects a plurality of download data from the second heterogeneous databases according to the download lists and receives the selected download data by the main sever; and
a data transmitting module, which transmits the download data to the first heterogeneous databases according to the download lists.

12. The system of claim 11, further comprising:
a first linking module, which establishes a plurality of first links between the main server and the first heterogeneous databases; and
a second linking module, which establishes a plurality of second links between the main server and the second heterogeneous databases according to the download lists.

13. The system of claim 11, wherein each of the download lists comprises:
designated download data, wherein the data retrieving module selects the download data from the second heterogeneous databases according to the designated download data listed in the download lists;
a download source, which indicates one of the second heterogeneous databases storing the designated download data to be downloaded;
a destination, which indicates one of the first heterogeneous databases, wherein the data transmitting module transmits the download data to one of the first heterogeneous databases indicated by the destination; and
a download tag, which is tagged to one of the designated download data, wherein the data retrieving module determines whether to receive the selected download data by the main sever according to the download tag.

14. The system of claim 13, further comprising:
a list processing module, which determines whether the download lists include duplicate data according to the designated download data and the download source of each of the download lists, wherein:
when the download lists include duplicate data, the list processing module tags one of the download lists with necessary downloading and the residual of the download lists with unnecessary downloading; and
when the download lists do not include duplicate data, the list processing module tags all of the download lists with necessary downloading.

15. The system of claim 14, wherein the list processing module further sorts the download lists according to at least one of the download source and the destination.

16. The system of claim 13, wherein:
the list establishing module establishes the destination, the designated download data and the download source in each of the download lists according to the first heterogeneous databases issuing the download requests and data to be downloaded designated in the download requests;
the data retrieving module selects the download data from the second heterogeneous databases according to the download source, the designated download data and the download tag of each of the download lists; and
the data transmitting module transmits the download data to the first heterogeneous databases according to the destination of each of the download lists.

17. The system of claim 13, wherein the data transmitting module transmits the download data to the first heterogeneous databases located in different time zones according to the destination of each of the download lists and a time zone of the destination.

18. The system of claim 11, further comprising:
a display module, which displays processing procedures of the system on a user interface.

19. The system of claim 11, wherein at least one of a group of the first links and a group of the second links are a plurality of Internet links.

20. The system of claim 11, wherein the main server excludes a database.
